(19) United States
(12) Patent Application Publication
(10) Pub. No.: US 2025/0024435 A1
(43) Pub. Date: Jan. 16, 2025

(54) SUB-BAND DETERMINATION FOR FLEXIBLE TIME UNITS IN WIRELESS COMMUNICATIONS

(71) Applicant: ZTE Corporation, Shenzhen (CN)

(72) Inventor: Peng HAO, Shenzhen (CN)

(73) Assignee: ZTE Corporation, Shenzhen, GD (CN)

(21) Appl. No.: 18/899,610

(22) Filed: Sep. 27, 2024

Related U.S. Application Data
(63) Continuation of application No. PCT/CN2022/139630, filed on Dec. 16, 2022.

(51) Int. Cl. H04W 72/044; H04W 72/11

(52) U.S. Cl. CPC H04W 72/044; H04W 72/11

(57) ABSTRACT

This document relates to wireless communication involving a network device transmitting, and a user device receiving, signaling that indicates to the user device at least one of: whether to use one of one or more sub-band configurations for a flexible time unit, a sub-band configuration for the flexible time unit, or a signal transmission rule for the flexible time unit. The user device and the network device communicate a signal transmission in the flexible time unit according to the signaling.

### CROSS-REFERENCE TO RELATED APPLICATIONS

This application is a continuation of International Patent Application No. PCT/CN2022/139630, filed Dec. 16, 2022. The contents of International Patent Application No. PCT/CN2022/139630 are herein incorporated by reference in their entirety.

### TECHNICAL FIELD

This document is directed generally to sub-band determination for flexible time units in wireless communication.

### BACKGROUND

In wireless communication, sub-band full duplex (SBFD) enables sub-band full duplex at gNB side with different resources. Meanwhile, a user device may operate in half duplex mode, meaning it only receives or only transmits at certain times, which in turn avoids increasing implementation complexity of user devices. Ways to efficiently enable SBFD operation in user devices may be desirable.

### SUMMARY

This document relates to methods, systems, apparatuses and devices for wireless communication. In some implementations, a method for wireless communication includes: receiving, by a user device, signaling that indicates to the user device at least one of: whether to use one of one or more sub-band configurations for a flexible time unit, a sub-band configuration for the flexible time unit, or a signal transmission rule for the flexible time unit; and communicating, by the user device, a signal transmission in the flexible time unit according to the signaling.

In some other implementations, a method for wireless communication includes: transmitting, by a network device, signaling that indicates to a user device at least one of: whether to use one of one or more sub-band configurations for a flexible time unit, a sub-band configuration for the flexible time unit, or a signal transmission rule for the flexible time unit; and communicating, by the network device, a signal transmission in the flexible unit according to the signaling.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows an example time-frequency diagram of an example configuration of time-frequency resources including one or more sub-bands.

FIG. 3 shows a flow chart of a method of wireless communication that involves flexible time units.

FIG. 4 shows a flow chart of another method of wireless communication that involves flexible time units.

FIG. 5 shows a time-frequency diagram of an example configuration of time-frequency resources including one or more sub-bands.

FIG. 6 shows a time-frequency diagram of another example configuration of time-frequency resources including one or more sub-bands.

FIG. 7 shows a time-frequency diagram of another example configuration of time-frequency resources including one or more sub-bands.

FIG. 8 shows a time-frequency diagram of another example configuration of time-frequency resources including one or more sub-bands.

FIG. 9 shows a time-frequency diagram of another example configuration of time-frequency resources including one or more sub-bands.

FIG. 10 shows a time-frequency diagram of another example configuration of time-frequency resources including one or more sub-bands.

FIG. 11 shows time-frequency diagrams of another example configuration of time-frequency resources including one or more sub-bands.

FIG. 12 shows a time-frequency diagram of another example configuration of time-frequency resources including one or more sub-bands.

### DETAILED DESCRIPTION

The present description describes various embodiments of systems, apparatuses, devices, and methods for wireless communications involving sub-bands, including signal/channel communication (transmission and/or reception) in downlink and/or uplink sub-bands in slots and/or symbols configured as flexible. Such embodiments may effectively and/or efficiently enable sub-band full duplex (SBFD) operation in flexible slots and/or symbols, and/or may simplify the complexity of device design and implementation. In addition or alternatively, the methods described herein may keep the flexibility provided by flexible slots (e.g., resources in a flexible slot or symbol may be changed to downlink (DL) or uplink (UL)), and/or may take advantage of sub-bands to enhance performance of SBFD operation, such as by performing filtering to suppress cross link interference (CLI) or rate matching and/or puncturing for channels or signals that occupy resources outside of sub-bands, based on sub-band configurations.

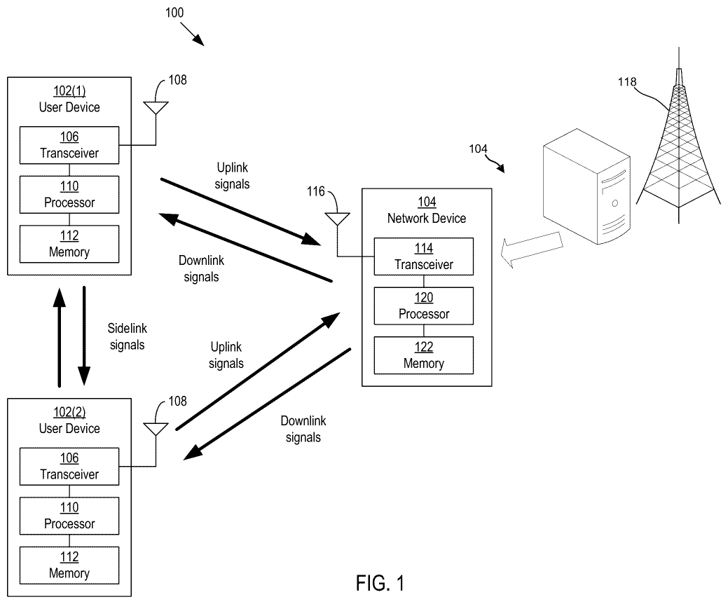

FIG. 1 shows a diagram of an example wireless communication system 100 including a plurality of communication nodes (or just nodes) that are configured to wirelessly communicate with each other. In general, the communication nodes include at least one user device 102 and at least one network device 104. The example wireless communication system 100 in FIG. 1 is shown as including two user devices 102, including a first user device 102(1) and a second user device 102(2), and one device 104. However, various other examples of the wireless communication system 100 that include any of various combinations of one or more user devices 102 and/or one or more network devices 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the network device 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a network device as described herein, such as the network device 104, may include a single electronic device or apparatus, or multiple (e.g., a network of) electronic devices or apparatuses, and may comprise one or more wireless access nodes, base stations, or other wireless network access points capable of communicating wirelessly over a network with one or more user devices and/or with one or more other network devices 104. For example, the network device 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A network device 104 may include transceiver circuitry 114 coupled to an antenna 116, which may include an antenna tower 118 in various approaches, to effect wireless communication with the user device 102 or another network device 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a network device 104, two user devices 102 without a network device 104, or two network devices 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a network device 104. A downlink signal is a signal transmitted from a network device 104 to a user device 102. A sidelink signal is a signal transmitted from a one user device 102 to another user device 102, or a signal transmitted from one network device 104 to a another network device 104. Also, for sidelink transmissions, a first/source user device 102 directly transmits a sidelink signal to a second/destination user device 102 without any forwarding of the sidelink signal to a network device 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a network device 104 to a user device 102. In other embodiments, the control information includes uplink control information (UCI) that is transmitted in the uplink direction from a user device 102 to a network device 104, or sidelink control information (SCI) that is transmitted in the sidelink direction from one user device 102(1) to another user device 102(2).

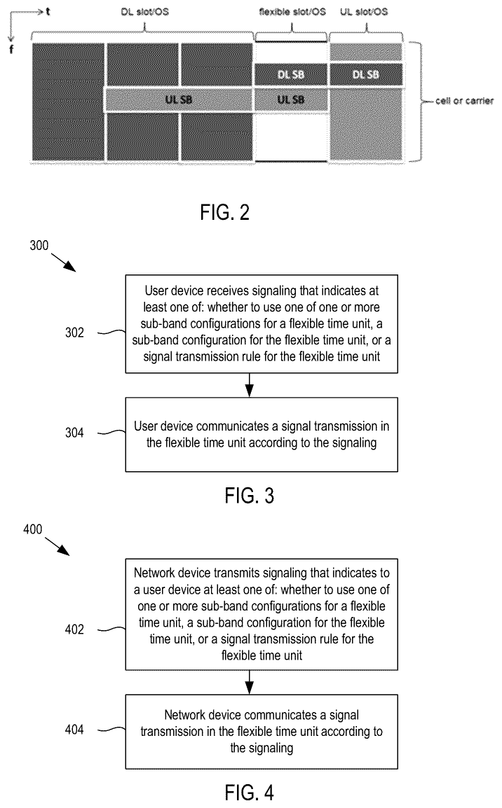

In addition, one or more of the user devices 102 and/or the network device 104 may support sub-band full duplex (SBFD). One difference between SBFD and conventional frequency-division duplex (FDD) systems is that, in SBFD, there is no specific frequency resource dedicated to downlink transmission or uplink transmission. Rather, one frequency resource can be used for downlink transmission, uplink transmission or both downlink and uplink transmission in a time-division duplex (TDD) manner. In addition, different frequency resources for SBFD can have different DL and/or UL slot configurations, and can be in the same frequency band. Additionally, SBFD can boost the coverage and reduce latency of communication as DL and/or UL resources are available at any time through proper configuration, although they may not be accessible at the same time. As shown in FIG. 2, one possible way to implement SBFD is to configure sub-bands (e.g. a downlink sub-band or an uplink sub-band) in a cell or carrier. A sub-band (SB) may be configured by configuring an UL (or DL) SB in a DL slot or symbol (e.g., an orthogonal frequency division multiplexing (OFDM) symbol (OS)), an UL SB and/or a DL SB in a flexible slot or symbol, or a DL (or UL) SB in an UL slot or symbol.

For at least some wireless communication systems (e.g., those implementing NR) system, frame structure or slot format can be configured as follows.

In event that a user device 102 receives or is provided with a cell-specific signaling that is applicable to all user devices 102 in one cell (e.g., “tdd-UL-DL-ConfigurationCommon”), the periodicity of the slot configuration and format of one or more slots or one or more symbols are configured. The format may include a DL symbol or slot, an UL symbol or slot, and a flexible symbol or slot.

In event that a user device 102 receives or is provided with a device-specific (e.g., UE-specific) signaling (e.g., “tdd-UL-DL-ConfigurationDedicated”), a flexible symbol configured by a cell-specific signaling (e.g., “tdd-UL-DL-ConfigurationCommon”) can be changed to DL or UL.

In event that a user device 102 does not receive or is not provided with a cell-specific signaling (e.g, “tdd-UL-DL-ConfigurationCommon”) and UE-specific signaling (e.g., “tdd-UL-DL-ConfigurationDedicated”), all symbols are regarded as having a “flexible” format or type.

The symbols configured via cell-specific signaling (e.g., “tdd-UL-DL-ConfigurationCommon”) and/or device-specific signaling (e.g., “tdd-UL-DL-ConfigurationDedicated”) as “flexible” can be dynamically indicated as DL or UL by DCI format 2.0 or scheduling signaling of a PDSCH or a PUSCH.

In addition, in some embodiments, a user device 102 and/or a network device 104 may operate according to one of the following SBFD operation configurations, at least for a radio resource control (RRC) connected (RRC_CONNECTED) state. In a first SBFD operation configuration, time and frequency locations of sub-bands for SBFD operation are not known to user devices 102. A behavior or functionality of a user device 102 may follow existing specifications without introducing new behavior or functionality for SBFD operation at the network device (gNB) 104 side. In a second SBFD operation configuration, time and frequency locations of sub-bands for SBFD operation are not known to user devices 102, user device 102 behavior or functionality for non-SBFD aware user device 102 may follow existing specifications, and from RAN1 perspective, new user device 102 behaviors or functionality can be introduced for SBFD-aware user devices 102. In a third SBFD operation configuration, only time location of sub-bands for SBFD operation is known to SBFD-aware user devices 102, user device 102 behavior or functionality for non-SBFD aware user devices 102 may follow existing specifications, and, from RAN1 perspective, new user device 102 behaviors or functionality can be introduced for SBFD aware user devices 102 based on the time location of sub-bands for SBFD operation. In a fourth SBFD operation configuration, both time and frequency locations of sub-bands for SBFD operation are known to SBFD aware user devices 102, user device 102 behaviors or functionality for non-SBFD aware user devices 102 follow existing specifications, and from RAN1 perspective, new user device 102 behaviors or functionality can be introduced for SBFD aware user devices 102 based on the time and frequency locations of sub-bands for SBFD operation. For some embodiments, the fourth SBFD operation configuration may serve or function as a baseline.

In some embodiments, for the fourth SBFD operation configuration, for an SBFD aware user device 102 configured with an UL sub-band in an SBFD symbol, a SBFD aware user device 102 may be configured to operate according to one or more of the following ways. In a first way, the SBFD aware user device 102 does not expect to be scheduled with UL transmission outside the UL sub-band or to be scheduled with DL reception within the UL subband in the SBFD symbol. In a second way, the SBFD aware user device 102 does not expect to be scheduled with UL transmission outside the UL subband and may be scheduled with DL reception within the UL subband in the SBFD symbol. In a third way, the SBFD aware user device 102 does not expect to be scheduled with DL reception within the UL subband and may be scheduled with UL transmission outside the UL subband in the SBFD symbol. In a fourth way, the SBFD aware user device 102 may be scheduled with UL transmission outside the UL subband or DL reception within the UL subband in the SBFD symbol.

In addition or alternatively, for some embodiments, for semi-static configuration of sub-band frequency locations for SBFD operation, at least explicit indication of frequency location of UL subband is made.

In addition or alternatively, for some embodiments, for a SBFD aware user device 102 that is semi-statically configured with a UL sub-band in a SBFD symbol configured as DL in cell-specific signaling (e.g., TDD-UL-DL-ConfigCommon), the following may be a baseline: UL transmissions within an UL sub-band are allowed in the SBFD symbol; UL transmissions outside of the UL sub-band are not allowed in the SBFD symbol; frequency locations of DL sub-band(s) are known to a SBFD aware user device 102; a frequency location of DL subband(s) can be explicitly indicated or implicitly derived; and DL receptions within DL sub-band(s) are allowed in the SBFD symbol. For at least some of these embodiments, UL transmissions are within an active UL bandwidth part (BWP) and DL receptions are within the active DL BWP in the SBFD symbol.

In addition or alternatively, for SBFD operation in a symbol configured as flexible in cell-specific signaling (e.g., TDD-UL-DL-ConfigCommon), an SBFD aware user device 102 may operated according to the following configurations. In a first configuration: UL transmissions within UL subband are allowed in the symbol; UL transmissions outside of the UL sub-band are not allowed in the symbol; frequency locations of DL subband(s) are known to the SBFD aware user device 102; and DL receptions within DL subband(s) are allowed in the symbol. In a second configuration: UL transmissions within UL subband are allowed in the symbol; the resource blocks (RBs) outside of the UL sub-band can be used as either UL, or DL excluding guardband(s) if used, in the symbol from network device's (gNB) 104 perspective, and the transmission direction for all those RBs is the same; frequency locations of DL subband(s) are known to the SBFD aware user device 102; DL receptions within DL subband(s) are allowed in the symbol. In addition, in some embodiments, UL transmissions are within an active UL BWP and DL receptions are within active DL BWP in the symbol for both the first and second configuration. For all RBs outside the UL sub-band, a user device 102 may not use separate RBs for DL and UL simultaneously.

The following describes signal and channel transmission and reception in DL and/or UL sub-bands in slots and/or symbols configured as flexible, which may effectively and efficiently enable SBFD operation in flexible slots and/or symbols and simplify the complexity of device design and implementation. Such signal and channel transmission and reception may keep the flexibility of flexible slots (i.e. resources in flexible slot/symbol can be changed to DL or UL) and take advantage of sub-bands to enhance performance of SBFD operation (e.g. perform filtering to suppress CLI or rate matching/puncturing for the channels/signals that occupy resources outside of sub-bands, based on sub-band configurations).

Also, for at least some embodiments for wireless communication, the network device 104 and the user device 102 may use time resources and frequency resources, or time-frequency resources, to communicate signals or information. A time resource may include one or more units of time. A unit of time may include a slot or a symbol, such as an orthogonal frequency-division multiplexing (OFDM) symbol. A frequency resource may include a range or band of frequencies. In particular embodiments, a set of time-frequency resources may extend over one time unit in the time domain and an active bandwidth part (BWP) in the frequency domain. Also, a given set of time-frequency resources may have certain type for wireless communication, including a downlink (DL) type, an uplink (UL) type, or a flexible type. A given set of time-frequency resources having the DL type means that those time-frequency resources are designated or configured for one or more DL transmissions. Also, a given set of time-frequency resources having the UL type means that those time-frequency resources are designated or configured for one or more UL transmissions. Also, as used herein, the term “flexible” as used for time and/or frequency resources, refers to that the user device 102 may not make any assumptions as to the uplink or downlink transmission direction for that time or frequency resource. The user device 102 may transmit in the UL direction or receive in the DL direction on or in a given flexible time or frequency resource, depending on any scheduling or other configuration, such as determined by the network device 104.

Also, some embodiments for wireless communication may utilize sub-bands. In general, a sub-band may include a range or band of frequencies that extends less than the full band of an active BWP. In the time domain, a sub-band may extend over one time unit or over multiple consecutive time units. The time-frequency resources for a sub-band may have the same or a different type than the type of the set of time-frequency resources over which the sub-band extends. For example, an UL sub-band (i.e., a sub-band having the UL type) may be configured in a DL slot (i.e., a slot having the DL type). In this example, a user device 102 may transmit an UL signal in the UL sub-band extending in the DL slot. As another example, a DL sub-band (i.e., a sub-band having the DL type) may be configured in an UL slot (i.e., a lot having the UL type). In this example, a user device may receive a DL signal in the DL sub-band extending in the UL slot.

FIG. 3 shows an example method 300 for wireless communication that involves one or more flexible time units, where each time unit may be a slot or a symbol. At block 302, a user device 102 may receive signaling that indicates to the user device 102 at least one of: whether to use one of one or more sub-band configurations for a flexible time unit, a sub-band configuration for the flexible time unit, or a signal transmission rule for the flexible time unit. At block 304, the user device 102 may communicate (including transmit and/or receive) a signal transmission in the flexible time unit according to the signaling.

FIG. 4 shows another example method 400 for wireless communication that involves one or more flexible time units, where each time unit may be a slot or a symbol. At block 402, a network device 104 may transmit signaling that indicates to a user device at least one of: whether to use one of one or more sub-band configurations for a flexible time unit, a sub-band configuration for the flexible time unit, or a signal transmission rule for the flexible time unit. At block 404, the network device 104 may communicate (including transmit and/or receive) a signal transmission in the flexible time unit according to the signaling.

In some embodiments of the method 300 and/or the method 400, the sub-band configuration for the flexible time unit comprises a first sub-band configuration or a second sub-band configuration. For some of these embodiments, when at least one of a dynamic slot form indicator (SFI) or user equipment (UE)-specific semi-static signaling indicates that the flexible time unit has a downlink type, or when the signaling indicates the first sub-band configuration for the flexible time unit, communicating the signal transmission in the flexible time unit according to the signaling comprises communicating the signal transmission in the flexible time unit according to the first sub-band configuration. In some of these embodiments, the first sub-band configuration comprises at least an uplink (UL) sub-band configuration.

In addition or alternatively, in some embodiments of the method 300 and/or the method 400, the sub-band transmission rule for the flexible time unit comprises a first transmission rule or a second transmission rule. For some of these embodiments, when a dynamic slot form indicator (SFI) or user equipment (UE)-specific semi-static signaling indicates that the flexible time unit has a downlink slot type, or when the signaling indicates the first signal transmission rule for the flexible slot, communicating the signal transmission in the flexible time unit according to the signaling comprises communicating the signal transmission in the flexible time unit according to the first signal transmission rule. In some of these embodiments, the first signal transmission rule is the same as a sub-band configuration used for a slot configured by cell-specific signaling to have a downlink type.

In addition or alternatively, in some embodiments of the method 300 and/or the method 400, when at least one of a dynamic slot form indicator (SFI) or user equipment (UE)-specific semi-static signaling indicates that the flexible time unit has an uplink type, or when the signaling indicates the second sub-band configuration for the flexible time unit, communicating the signal transmission in the flexible time unit according to the signaling comprises communicating the signal transmission in the flexible time unit according to the second sub-band configuration. In some of these embodiments, the second sub-band configuration comprises at least a downlink sub-band configuration.

In addition or alternatively, in some embodiments of the method 300 and/or the method 400, when at least one of a dynamic slot form indicator (SFI) or user equipment (UE)-specific semi-static signaling indicates that the flexible time unit has an uplink type, or when the signaling indicates the second signal transmission rule for the flexible time unit, communicating the signal transmission in the flexible time unit according to the signaling comprises communicating the signal transmission in the flexible time unit according to the second signal transmission rule. In some of these embodiments, the second signal transmission rule is the same as a sub-band configuration used for a time unit configured by cell-specific signaling to have an uplink type.

In addition or alternatively, in some embodiments of the method 300 and/or the method 400, when no dynamic slot form indicator (SFI) or user equipment (UE)-specific semi-static signaling indicates that the flexible time unit has an uplink type or a downlink type, the dynamic SFI or the UE-specific semi-static signaling indicates that the flexible time unit has a flexible type, the signaling indicates not to use the sub-band configuration, or the signaling indicates a third signal transmission rule, communicating the signal transmission according to the signaling comprises at least one of: communicating the signal transmission in the flexible time unit without an uplink sub-band configuration or a downlink sub-band configuration; or communicating the signal transmission in the flexible time unit according to the third signal transmission rule. In some of these embodiments, the third signal transmission rule indicates to perform the signal transmission in the flexible slot without according to the sub-band configuration.

In addition or alternatively, in some embodiments of the method 300 and/or the method 400, when no sub-band configuration applied when the flexible time unit is indicated as having a downlink type or an uplink type via a dynamic slot form indicator (SFI) or user equipment (UE)-specific semi-static signaling is indicated for the flexible time unit: all frequency resources in the flexible unit are used as downlink resources or uplink resources when the flexible time unit is indicated as having a downlink type or an uplink type, respectively, via the dynamic SFI or the UE-specific semi-static signaling; or the flexible time unit is not indicated as having the downlink type or the uplink type via the dynamic SFI or the UE-specific semi-static signaling.

In addition or alternatively, in some embodiments of the method 300 and/or the method 400, the sub-band configuration has an association with a downlink slot or symbol type or an uplink slot or symbol type, the association indicated via a dynamic slot form indicator (SFI) or user equipment (UE)-specific semi-static signaling, and wherein the flexible time unit is configured as having a flexible type by cell-specific signaling.

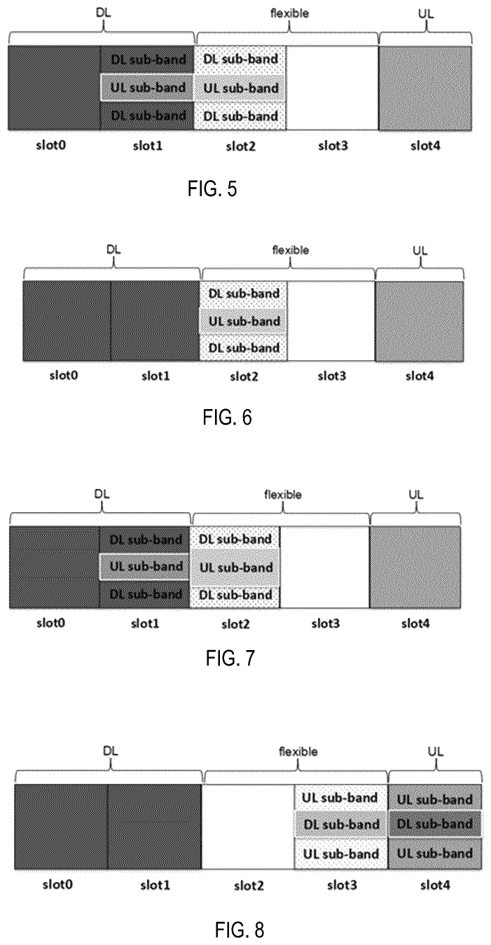

The following embodiments with reference to FIGS. 5-12 show configurations of sub-bands configured in or over time units configured as downlink, uplink, or flexible, and that may be used in combination with and/or for implementation of one or more of the embodiments of the method 300 and/or the method 400. The time units shown and described with reference to FIGS. 5-12, although time units other than slots, such as symbols, may be used. Also, the numbers of slots shown, and their particular DL/UL/flexible configurations are merely exemplary, and other similar configurations may be possible.

Referring to FIG. 5, cell specific signaling (e.g., “tdd-UL-DL-ConfigurationCommon”) may indicate to a user device 102 the time unit (slot) configuration as DDFFU, where “D” stands for DL, “U” stands for UL, “F” stands for flexible. In slot1, an UL sub-band is explicitly configured, and the remaining frequency resources (excluding guard band if any) are implicitly regarded as one or more DL sub-bands. In some embodiments, it is also possible that both the DL and UL sub-bands are explicitly configured.

Also, slot2 and slot3 are flexible slots. Slot2 is configured with a sub-band configuration that is the same as the sub-band configuration of slot1, and is used when the slot is indicated as DL via dynamic SFI (e.g. DCI format 2.0) and/or UE specific semi-static signaling (e.g. “tdd-UL-DL-ConfigurationDedicated”), or signaling explicitly indicates that the sub-band configuration is enabled. For example, the network device 104 indicates slot2 as having the DL type via dynamic SFI or device-specific signaling (e.g., “tdd-UL-DL-ConfigurationDedicated”. Alternatively, the network device (e.g., gNB) 104 may configure slot2 as flexible via device-specific signaling (e.g., “tdd-UL-DL-ConfigurationDedicated”) and indicate slot2 as DL. The sub-band configuration may be implemented or realized through an explicit UL sub-band configuration and implicitly determining or deriving the DL sub-band by excluding the UL sub-band (and any guard bands), or explicitly configuring the DL and UL sub-bands.

In addition, in some embodiments, when slot2 is indicated as DL, then slot1 and slot2 may share the same sub-band operation rules. For example, UL signals/channels may only be transmitted in an UL sub-band. DL signals/channels may be transmitted in a DL sub-band or in frequency resources other than for the UL sub-band. Additionally, DL signals/channels may not be transmitted in an UL sub-band.

Also, in some embodiments, when slot2 is indicated as UL via dynamic SFI (e.g. DCI format 2.0) and/or UE specific semi-static signaling (e.g. “tdd-UL-DL-ConfigurationDedicated”), then all frequency resources in slot2 is used as UL In addition or alternatively, in some embodiments, if there is no DL type indication via dynamic SFI (e.g. DCI format 2.0) and/or UE specific semi-static signaling (e.g. “tdd-UL-DL-ConfigurationDedicated”), the operations of slot2 may follow or correspond to those defined for flexible time units.

With reference to FIG. 6, cell-specific signaling (e.g., “tdd-UL-DL-ConfigurationCommon”) may indicate to a user device 102 the time unit (e.g., slot) configuration as DDFFU where “D” stands for DL, “U” stands for UL, and “F” stands for flexible. In the embodiment in FIG. 6, in contrast to the embodiment in FIG. 5, there is no DL and/or UL sub-band configuration in DL slots configured by cell-specific signaling (e.g., “tdd-UL-DL-ConfigurationCommon”). However, there is a signal transmission rule about operation in DL and/or UL sub-bands in DL slots configured by cell-specific signaling (e.g., “tdd-UL-DL-ConfigurationCommon”).

Also, in the configuration shown in FIG. 6, slot2 and slot3 are flexible slots. Slot2 is configured with a sub-band configuration that may be used when the slot is indicated as DL via dynamic SFI (e.g. DCI format 2.0) and/or UE specific semi-static signaling (e.g. “tdd-UL-DL-ConfigurationDedicated”). For example, the network device (gNB) 104 may indicate slot2 and/or slot3 as a DL slot via dynamic SFI or UE-specific signaling (e.g., “tdd-UL-DL-ConfigurationDedicated”), or the network device (gNB) 104 may configure it slot2 as flexible via UE-specific signaling (e.g., “tdd-UL-DL-ConfigurationDedicated”), and indicates slot2 as DL. The sub-band configuration may be realized or implemented through an explicit UL sub-band configuration and the DL sub-band may be implicitly determined or derived by excluding the UL sub-band (and guard band if any), or by explicitly configuring the DL and UL sub-bands.

Also, in some embodiments, when slot2 is indicated as DL, then slot1 and slot2 may share the same sub-band operation rules. For example, UL signals/channels may only be transmitted in a UL sub-band. DL signals/channels may be transmitted in a DL sub-band or in the frequency resources other than those used for the UL sub-band. Additionally, DL signals/channels may not be transmitted in a UL sub-band.

In addition, in some embodiments, if there is no DL type indication via dynamic SFI (e.g. DCI format 2.0) and/or UE-specific semi-static signaling (e.g. “tdd-UL-DL-ConfigurationDedicated”), or slot2 is indicated as flexible via dynamic SFI (e.g. DCI format 2.0) and/or UE-specific semi-static signaling (e.g. “tdd-UL-DL-ConfigurationDedicated”), or there is no dynamic SFI (e.g. DCI format 2.0) and/or UE specific semi-static signaling (e.g. “tdd-UL-DL-ConfigurationDedicated”), the operations of slot2 may follow those that are defined or predetermined for flexible slots.

With reference to FIG. 7, cell-specific signaling (e.g., “tdd-UL-DL-ConfigurationCommon”) may indicate to a user device 102 the slot configuration as DDFFU where “D” stands for DL, “U” stands for UL, and “F” stands for flexible.

In slot1, an UL sub-band is explicitly configured, and the remaining frequency resources (excluding guard band if any) may be implicitly determined as a DL sub-band. In some embodiments, both DL and UL sub-bands may be explicitly configured.

In addition, slot2 and slot3 are flexible slots. In contrast to the embodiment of FIG. 5, slot2 is configured with a sub-band configuration that is different from the sub-band configuration of slot1, and may be used when slot2 is indicated as DL via dynamic SFI (e.g. DCI format 2.0) and/or UE specific semi-static signaling (e.g. “tdd-UL-DL-ConfigurationDedicated”). For example, the user device (gNB) 104 may indicates slot2 as a DL slot via dynamic SFI or device-specific signaling (e.g., “tdd-UL-DL-ConfigurationDedicated”), or the network device (gNB) 104 may configure slot2 as flexible via device-specific signaling (e.g., “tdd-UL-DL-ConfigurationDedicated”) and may indicate slot2 as DL. The sub-band configuration may be implemented or realized through an explicit UL sub-band configuration and may be implicitly determined or derived to be a DL sub-band by excluding the UL sub-band (and guard band if any), or by explicitly configuring the DL and UL sub-bands.

In some embodiments, when slot2 is indicated as DL, then slot1 and slot2 may share the same sub-band operation (signal transmission) rules. For example, UL signals/channels may only be transmitted in a UL sub-band. DL signals/channels may be transmitted in a DL sub-band or in frequency resources other than those for a UL sub-band. DL signals/channels may not be transmitted in a UL sub-band.

Additionally, if there is no DL slot type indication via dynamic SFI (e.g. DCI format 2.0) and/or UE specific semi-static signaling (e.g. “tdd-UL-DL-ConfigurationDedicated”), the operations of slot2 may follow those that are defined for a flexible slot.

With reference to FIG. 8, cell-specific signaling (e.g., “tdd-UL-DL-ConfigurationCommon”) may indicate to a user device 102 the slot configuration as DDFFU where “D” stands for DL, “U” stands for UL, and “F” stands for flexible.

In slot4, a DL sub-band is explicitly configured, and the remaining frequency resources (excluding guard band if any) are implicitly regarded as a UL sub-band. In some embodiments, both DL and UL sub-band may be explicitly configured.

Additionally, slot2 and slot3 are flexible slots. Slot3 is configured with a sub-band configuration that is the same as the sub-band configuration for slot4, and may be used when slot3 is indicated as UL via dynamic SFI (e.g. DCI format 2.0) and/or UE specific semi-static signaling (e.g. “tdd-UL-DL-ConfigurationDedicated”). For example, the network device (gNB) 104 may indicate slot3 as UL slot via dynamic SFI or “tdd-UL-DL-ConfigurationDedicated”, or the network device (gNB) 104 configures slot3 as flexible via UE-specific signaling (e.g., “tdd-UL-DL-ConfigurationDedicated”) and indicates slot3 as UL. The sub-band configuration may be implemented or realized through an explicit UL sub-band configuration and implicitly deriving the DL sub-band by excluding the UL sub-band (and a guard band if any), or by explicitly configuring the DL and UL sub-bands.

Also, in some embodiments, when slot3 is indicated as UL, then slot3 and slot4 may share the same sub-band operation (signal transmission) rules. For example, UL signals/channels may be transmitted in a UL sub-band and or a DL sub-band. DL signals/channels may only be transmitted in a DL sub-band.

Also, in some embodiments, if there is no UL slot type indication via dynamic SFI (e.g. DCI format 2.0) and/or UE specific semi-static signaling (e.g. “tdd-UL-DL-ConfigurationDedicated”), the operations of slot3 may follow what is defined for a flexible slot.

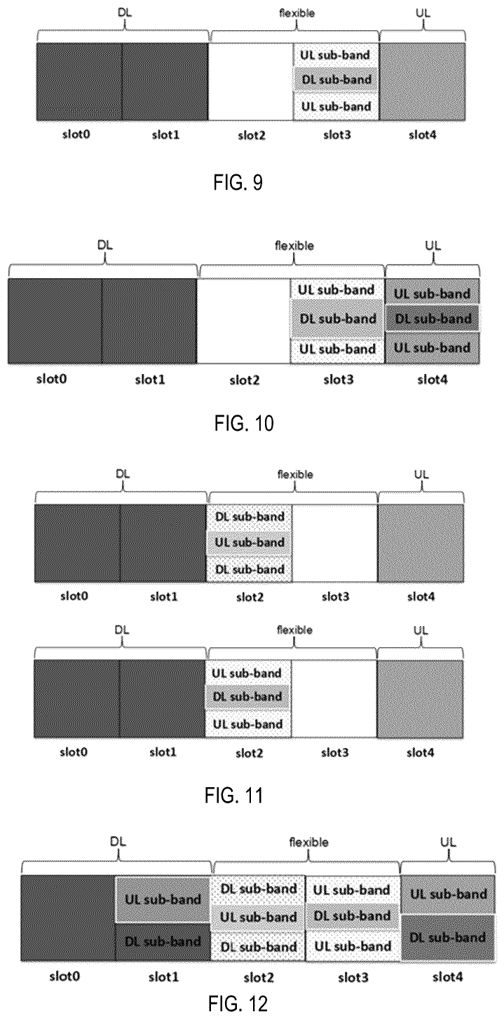

With reference to FIG. 9, cell-specific signaling (e.g., “tdd-UL-DL-ConfigurationCommon”) may indicate to the user device 102 the slot configuration as DDFFU where “D” stands for DL, “U” stands for UL, and “F” stands for flexible.

In contrast to the configuration in FIG. 8, there is no DL and/or UL sub-band configuration in UL slots configured by cell-specific signaling (e.g., “tdd-UL-DL-ConfigurationCommon”). However, there is a signal transmission rule about operation in DL and/or UL sub-band in UL slots configured by cell-specific signaling (e.g., “tdd-UL-DL-ConfigurationCommon”).

In addition, slot2 and slot3 are flexible slots. Slot3 is configured with a sub-band configuration which is used when slot3 is indicated as UL via dynamic SFI (e.g. DCI format 2.0) and/or UE-specific semi-static signaling (e.g. “tdd-UL-DL-ConfigurationDedicated”). For example, the network device (gNB) 104 may indicate slot3 as a UL slot via dynamic SFI or “tdd-UL-DL-ConfigurationDedicated”, or the network device (gNB) 104 may configure slot3 as flexible via “tdd-UL-DL-ConfigurationDedicated” and indicate slot3 as UL. The sub-band configuration may be implemented or realized through an explicit UL sub-band configuration and implicitly deriving a DL sub-band by excluding the UL sub-band (and a guard band if any), or by explicitly configuring the DL and UL sub-bands

In addition, in some embodiments, when slot3 is indicated as UL, then slot3 and slot4 may share the same sub-band signal transmission (operation) rules. For example, UL signals/channels may be transmitted in a UL sub-band and/or a DL sub-band. DL signals/channels may only be transmitted in a DL sub-band.

In addition, in some embodiments, if there is no UL slot type indication via dynamic SFI (e.g. DCI format 2.0) and/or UE specific semi-static signaling (e.g. “tdd-UL-DL-ConfigurationDedicated”), the operations of slot3 may follow those defined for a flexible slot.

### Embodiment 6

With reference to FIG. 10, cell-specific signaling (e.g., “tdd-UL-DL-ConfigurationCommon”) may indicate to a user device 102 the slot configuration as DDFFU where “D” stands for DL, “U” stands for UL, and “F” stands for flexible.

In slot4, a DL sub-band is explicitly configured, and the remaining frequency resources (excluding a guard band if any) are implicitly regarded as an UL sub-band. Also, in some embodiments, both the DL and UL sub-bands are explicitly configured.

In addition, slot2 and slot3 are flexible slots. In contrast to the embodiment in FIG. 8, slot3 is configured with a sub-band configuration that is different than the sub-band configuration of slot4, and may be used when slot3 is indicated as UL via dynamic SFI (e.g. DCI format 2.0) and/or UE specific signaling (e.g. “tdd-UL-DL-ConfigurationDedicated”). For example, the network device (gNB) 104 may indicate slot3 as a UL slot via dynamic SFI or “tdd-UL-DL-ConfigurationDedicated”, the network device (gNB) 104 may configures slot3 as flexible via device-specific signaling (e.g., “tdd-UL-DL-ConfigurationDedicated”) and may indicate slot3 as UL. The sub-band configuration may be realized or implemented through an explicit UL sub-band configuration and implicitly deriving a DL sub-band by excluding the UL sub-band (and guard band if any), or by explicitly configuring the DL and UL sub-bands.

In addition, in some embodiments, when slot3 is indicated as UL, then slot3 and slot4 may share the same sub-band signal transmission (operation) rules. For example, UL signals/channels may be transmitted in a UL sub-band and/or a DL sub-band. Also, DL signals/channels may only be transmitted in a DL sub-band.

Additionally, in some embodiments, if there is no UL slot type indication via dynamic SFI (e.g. DCI format 2.0) and/or UE specific semi-static signaling (e.g. “tdd-UL-DL-ConfigurationDedicated”), the operations of slot3 may follow those defined for a flexible slot.

### Embodiment 7

With reference to FIG. 11, cell-specific signaling (e.g., “tdd-UL-DL-ConfigurationCommon”) may indicate to the user device 102 the slot configuration as DDFFU, where “D” stands for DL, “U” stands for UL, and “F” stands for flexible.

In the embodiment in FIG. 11, there is no DL and/or UL sub-band configuration in DL slots and UL slots configured by cell-specific signaling (e.g., “tdd-UL-DL-ConfigurationCommon”), but there is a signal transmission rule about operation in DL and/or UL sub-band in DL slots and UL slots configured by cell-specific signaling (e.g., “tdd-UL-DL-ConfigurationCommon”).

Also, in the embodiment in FIG. 11, slot2 and slot3 are flexible slots. Slot2 is configured with two sub-band configurations that are used when slot2 is indicated as DL and UL respectively via dynamic SFI (e.g. DCI format 2.0) and/or UE specific semi-static signaling (e.g. “tdd-UL-DL-ConfigurationDedicated”). For example, the network device (gNB) 104 may indicate slot2 as a DL slot via dynamic SFI or “tdd-UL-DL-ConfigurationDedicated”, or the network device (gNB) 104 may configure slot2 as flexible via “tdd-UL-DL-ConfigurationDedicated” and may indicates slot2 as DL. The sub-band configuration may be implemented or realized through an explicit UL sub-band configuration and implicitly deriving a DL sub-band by excluding the UL sub-band (and a guard band if any), or by explicitly configuring the DL and UL sub-bands.

Also, in some embodiments, when slot2 is indicated as DL (upper diagram in FIG. 11), then the DL slot0 and DL slot1 and slot2 may share the same sub-band signal transmission (operation) rules. For example, UL signals/channels may only be transmitted in an UL sub-band. In addition or alternatively, DL signals/channels may be transmitted in a DL sub-band or in frequency resources other than the UL sub-band. In addition or alternatively, DL signals/channels may not be transmitted in a UL sub-band.

Additionally, in some embodiments, when slot2 is indicated as UL (bottom diagram in FIG. 11), then the UL slot4 and slot2 may share the same sub-band signal transmission (operation) rules. For example, UL signals/channels can be transmitted in an UL sub-band and/or a DL sub-band. In addition or alternatively, DL signals/channels may only be transmitted in a DL sub-band.

In addition, in some embodiments, if there is no DL slot type indication via dynamic SFI (e.g. DCI format 2.0) and/or UE specific semi-static signaling (e.g. “tdd-UL-DL-ConfigurationDedicated”), the operations of slot2 may follow those defined for a flexible slot.

### Embodiment 8

Referring to FIG. 12, cell-specific signaling (e.g., “tdd-UL-DL-ConfigurationCommon”) may indicate to a user device 102 the slot configuration as DDFFU, where “D” stands for DL, “U” stands for UL, and “F” stands for flexible.

Also, in the embodiment in FIG. 12, slot2 and slot3 are flexible slots. Further, slot1, slot2, slot3, and slot4 are configured with sub-band configurations. For slot1, there is a UL (or DL) sub-band in the sub-band configuration, which is explicitly indicated. The remaining resources (excluding a potential guard band if any) below and/or above the UL (or DL) sub-band may be regarded as a DL (or an UL) sub-band. The DL (or the UL) sub-band can also be explicitly indicated.

In addition, in the embodiment in FIG. 12, there is sub-band configuration for slot2 that is used when slot2 is indicated as DL via dynamic SFI (e.g. DCI format 2.0) and/or UE specific semi-static signaling (e.g. “tdd-UL-DL-ConfigurationDedicated”), or is explicitly indicated when the sub-band configuration is enabled. For example, the network device (gNB) 104 may indicate slot2 as a DL slot via dynamic SFI or “tdd-UL-DL-ConfigurationDedicated”, or the network device (gNB) 104 may configure slot2 as flexible via device-specific signaling (e.g., “tdd-UL-DL-ConfigurationDedicated”) and may indicate slot2 as DL. The sub-band configuration may be implemented or realized through an explicit UL (or DL) sub-band configuration and implicitly deriving a DL (or an UL) sub-band by excluding the UL (or the DL) sub-band (and a guard band if any), or by explicitly configuring the DL and the UL sub-bands.

Also, in the embodiment in FIG. 12, there is sub-band configuration for slot3 that is used when slot3 is indicated as UL via dynamic SFI (e.g. DCI format 2.0) and/or UE specific semi-static signaling (e.g. “tdd-UL-DL-ConfigurationDedicated”), or is explicitly indicated when the sub-band configuration is enabled. For example, gNB indicates it as UL slot via dynamic SFI or “tdd-UL-DL-ConfigurationDedicated”. or gNB configures it as flexible via “tdd-UL-DL-ConfigurationDedicated” and indicates it as UL. The sub-band configuration can be realized through a explicit DL (or UL) sub-band configuration and implicitly deriving UL (or DL) sub-band by excluding DL (or UL) sub-band (and guard band if any), or explicitly configuring DL and UL sub-band.

Additionally, for slot4, there is a DL (or UL) sub-band in the sub-band configuration, which is explicitly indicated. The remaining resources (excluding a potential guard band if any) above (or below) the DL (or UL) sub-band may be regarded as an UL (or a DL) sub-band. Alternatively, the UL (or the DL) sub-band may also be explicitly indicated.

Additionally, in some embodiments, when slot2 is indicated as DL, then slot1 and slot2 may share the same sub-band signal transmission (operation) rules. For example, UL signals/channels may only be transmitted in an UL sub-band. In addition or alternatively, DL signals/channels may be transmitted in a DL sub-band or in the frequency resources other than an UL sub-band. In addition or alternatively, DL signals/channels may not be transmitted in an UL sub-band.

Also, in some embodiments, when slot3 is indicated as UL, then slot4 and slot3 share the same sub-band signal transmission (operation) rules. For example, UL signals/channels may be transmitted in an UL sub-band and or a DL sub-band. In addition or alternatively, DL signals/channels may only be transmitted in a DL sub-band.

Additionally, in some embodiments, if there is no DL slot type indication via dynamic SFI (e.g. DCI format 2.0) and/or UE specific semi-static signaling (e.g. “tdd-UL-DL-ConfigurationDedicated”) for slot2, or dynamic SFI (e.g. DCI format 2.0) and/or UE specific semi-static signaling (e.g. “tdd-UL-DL-ConfigurationDedicated”) indicates slot2 as a flexible slot, the operations of slot2 may follow those defined for a flexible slot.

Also, in the embodiment in FIG. 12, as there is no sub-band configuration associated with an UL slot for slot2, all frequency resources of slot2 may be used for UL transmission when dynamic SFI (e.g. DCI format 2.0) and/or UE specific semi-static signaling (e.g. “tdd-UL-DL-ConfigurationDedicated”) indicates slot2 as UL, or slot 2 may not be indicated as UL by dynamic SFI (e.g. DCI format 2.0) and/or UE specific semi-static signaling (e.g. “tdd-UL-DL-ConfigurationDedicated”).

In addition, in some embodiments, if there is no UL type indication via dynamic SFI (e.g. DCI format 2.0) and/or UE specific semi-static signaling (e.g. “tdd-UL-DL-ConfigurationDedicated”) for slot3, or dynamic SFI (e.g. DCI format 2.0) and/or UE specific semi-static signaling (e.g. “tdd-UL-DL-ConfigurationDedicated”) indicates slot3 as a flexible slot, the operations of slot3 may follow those defined for a flexible slot.

Also, in the embodiment in FIG. 12, as there is no sub-band configuration associated with a DL slot for slot3, all frequency resources of slot3 may be used for DL transmission when dynamic SFI (e.g. DCI format 2.0) and/or UE specific semi-static signaling (e.g. “tdd-UL-DL-ConfigurationDedicated”) indicates slot3 as DL, or slot 3 may not be indicated as DL by dynamic SFI (e.g. DCI format 2.0) and/or UE specific semi-static signaling (e.g. “tdd-UL-DL-ConfigurationDedicated”).

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: receiving, by a user device, signaling that indicates to the user device at least one of: whether to use one of one or more sub-band configurations for a flexible time unit, a sub-band configuration for the flexible time unit, or a signal transmission rule for the flexible time unit; and communicating, by the user device, a signal transmission in the flexible time unit according to the signaling.

A second aspect includes a method for wireless communication that includes: transmitting, by a network device, signaling that indicates to a user device at least one of: whether to use one of one or more sub-band configurations for a flexible time unit, a sub-band configuration for the flexible time unit, or a signal transmission rule for the flexible time unit; and communicating, by the network device, a signal transmission in the flexible unit according to the signaling.

A third aspect includes any of the first or second aspects, and further includes wherein the sub-band configuration for the flexible time unit comprises a first sub-band configuration or a second sub-band configuration.

A fourth aspect includes the third aspect, and further includes wherein when at least one of a dynamic slot form indicator (SFI) or user equipment (UE)-specific semi-static signaling indicates that the flexible time unit has a downlink type, or when the signaling indicates the first sub-band configuration for the flexible time unit, communicating the signal transmission in the flexible time unit according to the signaling comprises communicating the signal transmission in the flexible time unit according to the first sub-band configuration.

A fifth aspect includes the fourth aspect, and further includes wherein the first sub-band configuration comprises at least an uplink (UL) sub-band configuration.

A sixth aspect includes any of the first through fifth aspects, and further includes wherein the sub-band transmission rule for the flexible time unit comprises a first transmission rule or a second transmission rule.

A seventh aspect includes the sixth aspect, and further includes wherein when at least one of a dynamic slot form indicator (SFI) or user equipment (UE)-specific semi-static signaling indicates that the flexible time unit has a downlink type, or when the signaling indicates the first signal transmission rule for the flexible slot, communicating the signal transmission in the flexible time unit according to the signaling comprises communicating the signal transmission in the flexible time unit according to the first signal transmission rule.

An eighth aspect includes the seventh aspect, and further includes wherein the first signal transmission rule is the same as a sub-band configuration used for a slot configured by cell-specific signaling to have a downlink type.

A ninth aspect includes any of the third through eighth aspects, and further includes wherein when at least one of a dynamic slot form indicator (SFI) or user equipment (UE)-specific semi-static signaling indicates that the flexible time unit has an uplink type, or when the signaling indicates the second sub-band configuration for the flexible time unit, communicating the signal transmission in the flexible time unit according to the signaling comprises communicating the signal transmission in the flexible time unit according to the second sub-band configuration.

A tenth aspect includes the ninth aspect, and further includes wherein the second sub-band configuration comprises at least a downlink sub-band configuration.

An eleventh aspect includes any of the sixth through tenth aspects, and further includes wherein when at least one of a dynamic slot form indicator (SFI) or user equipment (UE)-specific semi-static signaling indicates that the flexible time unit has an uplink type, or when the signaling indicates the second signal transmission rule for the flexible time unit, communicating the signal transmission in the flexible time unit according to the signaling comprises communicating the signal transmission in the flexible time unit according to the second signal transmission rule.

A twelfth aspect includes the eleventh aspect, and further includes wherein the second signal transmission rule is the same as a sub-band configuration used for a time unit configured by cell-specific signaling to have an uplink type.

A thirteenth aspect includes any of the first through twelfth aspects, and further includes wherein when no dynamic slot form indicator (SFI) or user equipment (UE)-specific semi-static signaling indicates that the flexible time unit has an uplink type or a downlink type, the dynamic SFI or the UE-specific semi-static signaling indicates that the flexible time unit has a flexible type, the signaling indicates not to use the sub-band configuration, or the signaling indicates a third signal transmission rule, communicating the signal transmission according to the signaling comprises at least one of: communicating the signal transmission in the flexible time unit without an uplink sub-band configuration or a downlink sub-band configuration; or communicating the signal transmission in the flexible time unit according to the third signal transmission rule.

A fourteenth aspect includes the thirteenth aspect, and further includes wherein the third signal transmission rule indicates to perform the signal transmission in the flexible slot without according to the sub-band configuration.

A fifteenth aspect includes any of the first through fourteenth aspects, and further includes wherein when no sub-band configuration applied when the flexible time unit is indicated as having a downlink type or an uplink type via a dynamic slot form indicator (SFI) or user equipment (UE)-specific semi-static signaling is indicated for the flexible time unit: all frequency resources in the flexible unit are used as downlink resources or uplink resources when the flexible time unit is indicated as having a downlink type or an uplink type, respectively, via the dynamic SFI or the UE-specific semi-static signaling; or the flexible time unit is not indicated as having the downlink type or the uplink type via the dynamic SFI or the UE-specific semi-static signaling.

A sixteenth aspect includes any of the first through fifteenth aspects, and further includes wherein the sub-band configuration has an association with a downlink type or an uplink type, the association indicated via a dynamic slot form indicator (SFI) or user equipment (UE)-specific semi-static signaling, and wherein the flexible time unit is configured as having a flexible type by cell-specific signaling.

A seventeenth aspect includes a wireless communications apparatus comprising a processor and a memory, wherein the processor is configured to read code from the memory to implement any of the first through sixteenth aspects.

An eighteenth aspect includes a computer program product comprising a computer-readable program medium comprising code stored thereupon, the code, when executed by a processor, causing the processor to implement any of the first through sixteenth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
receiving, by a user device, signaling that indicates to the user device at least one of: whether to use one of one or more sub-band configurations for a flexible time unit, a sub-band configuration for the flexible time unit, or a signal transmission rule for the flexible time unit; and
communicating, by the user device, a signal transmission in the flexible time unit according to the signaling.

2. The method of claim 1, wherein the sub-band configuration for the flexible time unit comprises a first sub-band configuration or a second sub-band configuration.

3. The method of claim 2, wherein when at least one of a dynamic slot form indicator (SFI) or user equipment (UE)-specific semi-static signaling indicates that the flexible time unit has a downlink type, or when the signaling indicates the first sub-band configuration for the flexible time unit, communicating the signal transmission in the flexible time unit according to the signaling comprises communicating the signal transmission in the flexible time unit according to the first sub-band configuration.

4. The method of claim 3, wherein the first sub-band configuration comprises at least an uplink (UL) sub-band configuration.

5. The method of claim 2, wherein when at least one of a dynamic slot form indicator (SFI) or user equipment (UE)-specific semi-static signaling indicates that the flexible time unit has an uplink type, or when the signaling indicates the second sub-band configuration for the flexible time unit, communicating the signal transmission in the flexible time unit according to the signaling comprises communicating the signal transmission in the flexible time unit according to the second sub-band configuration.

6. The method of claim 5, wherein the second sub-band configuration comprises at least a downlink sub-band configuration.

7. The method of claim 1, wherein the sub-band transmission rule for the flexible time unit comprises a first transmission rule or a second transmission rule.

8. The method of claim 7, wherein when at least one of a dynamic slot form indicator (SFI) or user equipment (UE)-specific semi-static signaling indicates that the flexible time unit has a downlink type, or when the signaling indicates the first signal transmission rule for the flexible slot, communicating the signal transmission in the flexible time unit according to the signaling comprises communicating the signal transmission in the flexible time unit according to the first signal transmission rule.

9. The method of claim 8, wherein the first signal transmission rule is the same as a sub-band configuration used for a slot configured by cell-specific signaling to have a downlink type.

10. The method of claim 7, wherein when at least one of a dynamic slot form indicator (SFI) or user equipment (UE)-specific semi-static signaling indicates that the flexible time unit has an uplink type, or when the signaling indicates the second signal transmission rule for the flexible time unit, communicating the signal transmission in the flexible time unit according to the signaling comprises communicating the signal transmission in the flexible time unit according to the second signal transmission rule.

11. A method for wireless communication, the method comprising:
transmitting, by a network device, signaling that indicates to a user device at least one of: whether to use one of one or more sub-band configurations for a flexible time unit, a sub-band configuration for the flexible time unit, or a signal transmission rule for the flexible time unit; and
communicating, by the network device, a signal transmission in the flexible unit according to the signaling.

12. The method of claim 11, wherein the sub-band configuration for the flexible time unit comprises a first sub-band configuration or a second sub-band configuration.

13. The method of claim 11, wherein the sub-band transmission rule for the flexible time unit comprises a first transmission rule or a second transmission rule.

14. The method of claim 13, wherein when at least one of a dynamic slot form indicator (SFI) or user equipment (UE)-specific semi-static signaling indicates that the flexible time unit has an uplink type, or when the signaling indicates the second signal transmission rule for the flexible time unit, communicating the signal transmission in the flexible time unit according to the signaling comprises communicating the signal transmission in the flexible time unit according to the second signal transmission rule.

15. The method of claim 14, wherein the second signal transmission rule is the same as a sub-band configuration used for a time unit configured by cell-specific signaling to have an uplink type.

16. The method of claim 11, wherein when no dynamic slot form indicator (SFI) or user equipment (UE)-specific semi-static signaling indicates that the flexible time unit has an uplink type or a downlink type, the dynamic SFI or the UE-specific semi-static signaling indicates that the flexible time unit has a flexible type, the signaling indicates not to use the sub-band configuration, or the signaling indicates a third signal transmission rule, communicating the signal transmission according to the signaling comprises at least one of:
communicating the signal transmission in the flexible time unit without an uplink sub-band configuration or a downlink sub-band configuration; or
communicating the signal transmission in the flexible time unit according to the third signal transmission rule.

17. The method of claim 16, wherein the third signal transmission rule indicates to perform the signal transmission in the flexible slot without according to the sub-band configuration.

18. The method of claim 11, wherein when no sub-band configuration applied when the flexible time unit is indicated as having a downlink type or an uplink type via a dynamic slot form indicator (SFI) or user equipment (UE)-specific semi-static signaling is indicated for the flexible time unit:
all frequency resources in the flexible unit are used as downlink resources or uplink resources when the flexible time unit is indicated as having a downlink type or an uplink type, respectively, via the dynamic SFI or the UE-specific semi-static signaling; or
the flexible time unit is not indicated as having the downlink type or the uplink type via the dynamic SFI or the UE-specific semi-static signaling.

19. The method of claim 11, wherein the sub-band configuration has an association with a downlink type or an uplink type, the association indicated via a dynamic slot form indicator (SFI) or user equipment (UE)-specific semi-static signaling, and wherein the flexible time unit is configured as having a flexible type by cell-specific signaling.

20. A wireless communications apparatus comprising:
a memory storing a plurality of instructions; and
a processor configured to execute the plurality of instructions, wherein upon execution of the plurality of instructions, the processor is configured to:
receive signaling that indicates to the wireless communications apparatus at least one of: whether to use one of one or more sub-band configurations for a flexible time unit, a sub-band configuration for the flexible time unit, or a signal transmission rule for the flexible time unit; and
communicate a signal transmission in the flexible time unit according to the signaling.
